(19) United States
(12) Patent Application Publication
(10) Pub. No.: US 2024/0198820 A1
(43) Pub. Date: Jun. 20, 2024

(54) FUEL CELL VEHICLE

(71) Applicant: Isuzu Motors Limited, Kanagawa (JP)

(72) Inventors: Ryou ISHIDA, Kanagawa (JP); Kouhei NAGAI, Kanagawa (JP)

(73) Assignee: Isuzu Motors Limited, Kanagawa (JP)

(21) Appl. No.: 18/539,334

(22) Filed: Dec. 14, 2023

(30) Foreign Application Priority Data
Dec. 15, 2022 (JP) 2022-200146

(51) Int. Cl. B60L 50/71; H01M 8/0444; H01M 8/04664

(52) U.S. Cl. CPC B60L 50/71; H01M 8/04447; H01M 8/04664; H01M 2250/20

(57) ABSTRACT

A fuel cell vehicle includes: a cab floor formed higher at a rear portion than at a front portion by a step portion obliquely inclined upward and rearward in a vehicle length direction; and a fuel cell system disposed below the cab floor, the fuel cell vehicle being configured to travel using electric power generated by the fuel cell system, in which the rear portion of the cab floor has a shape for accumulating fuel leaking and ascending from the fuel cell system.

### CROSS REFERENCE TO RELATED APPLICATIONS

This application claims the benefit of priority of Japanese Patent Application No. 2022-200146, filed on Dec. 15, 2022, the contents of which are incorporated by reference as if fully set forth herein in their entirety.

### TECHNICAL FIELD

The present disclosure relates to a fuel cell vehicle.

### BACKGROUND ART

A Fuel Cell Vehicle (FCV) is known in which a tank for storing fuel (e.g., hydrogen, etc.), a fuel cell system for generating electric power using the fuel, and a motor for driving using the electric power generated by the fuel cell system are mounted and which is driven by driving of the motor.

### CITATION LIST

### Patent Literature

### PTL 1

Japanese Patent Application Laid-Open No. 2009-170209

### SUMMARY OF INVENTION

### Technical Problem

Conventionally, in a fuel cell vehicle such as a truck, fuel leaked from a fuel cell system disposed below a cab is collected using a predetermined component, but there is a problem that the number of components increases.

An object of one aspect of the present disclosure is to provide a fuel cell vehicle capable of reducing the number of parts for collecting leaked fuel.

### Solution to Problem

In order to achieve the above object, a fuel cell vehicle according to an aspect of the present disclosure includes: a cab floor formed higher at a rear portion than at a front portion by a step portion obliquely inclined upward and rearward in a vehicle length direction; and a fuel cell system disposed below the cab floor, the fuel cell vehicle being configured to travel using electric power generated by the fuel cell system, in which the rear portion of the cab floor has a shape for accumulating fuel leaking and ascending from the fuel cell system.

### Advantageous Effects of Invention

According to the present disclosure, it is possible to reduce the number of parts for collecting leaked fuel.

### BRIEF DESCRIPTION OF DRAWINGS

FIG. 1 is a schematic diagram illustrating an example of a cab according to an aspect of an embodiment of the present disclosure;

FIG. 2A is a side view schematically illustrating an exemplary cab floor;

FIG. 2B is a front view schematically illustrating the exemplary cab floor;

FIG. 3A is a side view schematically illustrating an exemplary cab floor according to an aspect of an embodiment of the present disclosure; and

FIG. 3B is a front view schematically illustrating the exemplary cab floor according to an aspect of the embodiment of the present disclosure.

### DESCRIPTION OF EMBODIMENTS

Hereinafter, an embodiment of the present disclosure will be described with reference to the drawings. Note that, in all the drawings, an element the same as a precedent element is given the same reference numeral, and the description thereof may be omitted.

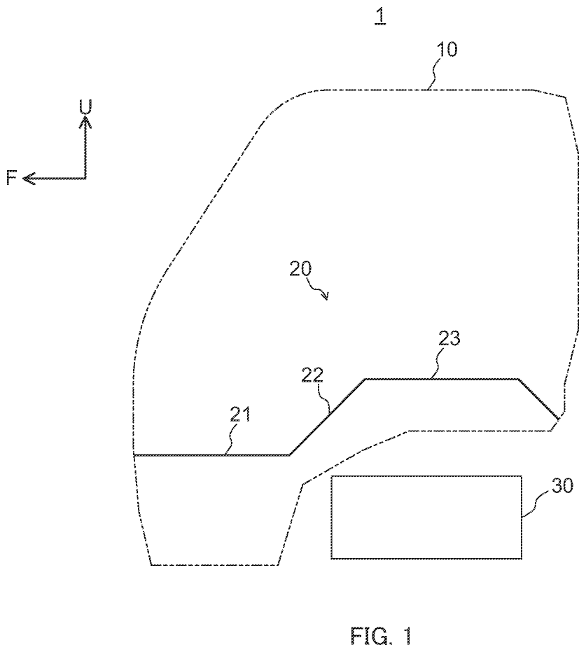

Truck 1 (an example of a fuel cell vehicle) according to the present embodiment will be described with reference to FIG. 1. FIG. 1 is a schematic diagram illustrating an example of cab 10 of truck 1 according to the present embodiment. In FIG. 1, the direction indicated by arrow F is the front of truck 1, and the direction indicated by arrow U is the upper side of truck 1.

As illustrated in FIG. 1, truck 1 includes cab 10 and Fuel Cell System (FCS) 30. Although not illustrated, a cargo compartment, a platform, or the like may be disposed behind cab 10.

Cab 10 is provided with cab floor 20 (described in detail later). Further, fuel cell system 30 is disposed below cab floor 20.

Although not illustrated, for example, a plurality of hydrogen tanks are disposed behind cab 10. Hydrogen (an example of fuel) is stored in each of the hydrogen tanks, and hydrogen in each of the hydrogen tanks is supplied to fuel cell system 30.

Fuel cell system 30 generates electric power using hydrogen supplied from the hydrogen tanks. Although not illustrated, fuel cell system 30 includes a fuel cell stack and auxiliary devices (for example, an air-compressor, a DC-DC converter, and the like). Although not illustrated, truck 1 is equipped with a motor that is driven using electric power supplied from fuel cell system 30. The driving of motor causes truck 1 to travel.

Although the basic configuration has been described above, truck 1 of the present embodiment is characterized in that cab floor 20 having the shape illustrated in FIG. 1 is disposed.

Cab floor 20 includes front portion 21 positioned in the front of cab 10, rear portion 23 positioned in the rear of cab 10, and step portion 22 positioned between front portion 21 and rear portion 23.

Step portion 22 is obliquely inclined rearward and upward in the vehicle length direction (left-right direction in the figure) of truck 1. By step portion 22, cab floor 20 is formed higher at rear portion 23 than at front portion 21.

In addition, rear portion 23 has a shape for accumulating hydrogen that leaks and ascends from fuel cell system 30 (hereinafter referred to as leaked hydrogen). Specifically, as illustrated in FIG. 1, a rear end portion of rear portion 23 is obliquely inclined downward and rearward in the vehicle length direction.

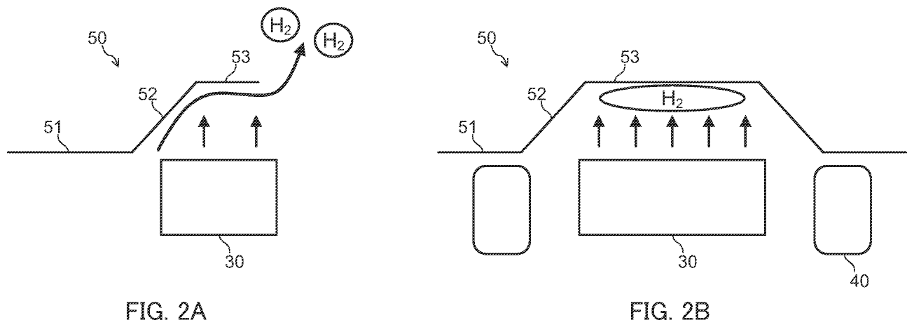

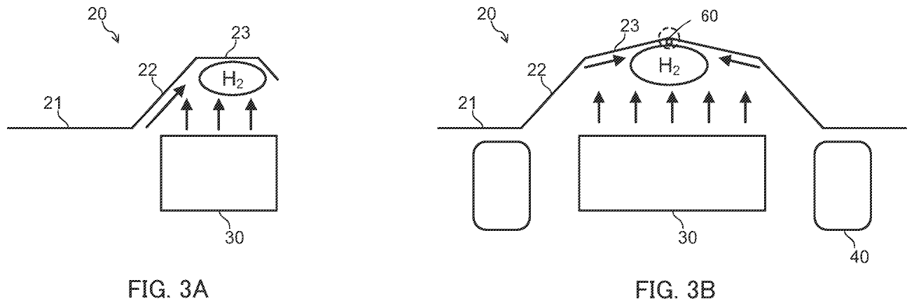

Here, a description will be given of a difference in the effects between conventional cab floor 50 and cab floor 20 of the present embodiment with reference to FIGS. 2A, 2B, 3A, and 3B. FIG. 2A is a side view schematically illustrating an example of conventional cab floor 50, and FIG. 2B is a front view schematically illustrating an example of conventional cab floor 50. FIG. 3A is a side view schematically illustrating an example of cab floor 20 of the present embodiment, and FIG. 3B is a front view schematically illustrating an example of cab floor 20 of the present embodiment. It should be noted that H₂ illustrated in the figures represent leaked hydrogen, and the arrows illustrated in the figures indicate the movement of the leaked hydrogen. Further, reference numeral 40 illustrated in FIGS. 2B and 3B indicates wheels of truck 1.

Conventional cab floor 50, like cab floor 20, includes front portion 51, step portion 52, and rear portion 53. However, as illustrated in FIG. 2A, the rear end portion of rear portion 53 has a horizontal shape which is not inclined upward or downward.

As illustrated in FIG. 2A, when such a cab floor 50 is used, leaked hydrogen H₂ is basically discharged from the rear of cab floor 50 into the atmosphere without being collected. Further, as illustrated in FIG. 2B, even when leaked hydrogen H₂ remains below cab floor 50 (e.g., rear step 53), the remaining range is wide and the concentration is low. Therefore, even when a hydrogen sensor (not illustrated) capable of detecting the leaked hydrogen is installed below cab floor 50, it is difficult to accurately detect the leaked hydrogen.

On the other hand, when cab floor 20 of the present embodiment is used, leaked hydrogen H₂ is accumulated below cab floor 20 (for example, rear step 23) as illustrated in FIGS. 3A and 3B. In particular, when truck 1 is parked, leaked hydrogen H₂ tends to temporarily accumulate. When truck 1 travels, temporarily accumulated leaked hydrogen H₂ is easily discharged into the atmosphere.

In addition, when hydrogen sensor 60 is installed at a location where leaked hydrogen H₂ is accumulated (for example, a portion indicated by a dotted circle in FIG. 3B), the detection accuracy is enhanced.

As described above, in truck 1 of the present embodiment, rear portion 23 of cab floor 20 has a shape for accumulating leaked hydrogen H₂. It is thus possible to collect leaked hydrogen H₂ without using a retrofitted component or the like. Accordingly, the number of parts used for the leaked hydrogen collection can be reduced.

By reducing the number of parts as described above, the number of assembly steps can be reduced, and the degree of freedom in layout of cooling pipes, harnesses, and the like is increased.

When the degree of freedom of the layout is increased, removal of parts that have been conventionally performed in order to facilitate inserting hands and/or tools during maintenance work (including, for example, replacement of fuel cell system 30) is reduced, and access to a target of the maintenance work is improved.

Further, leaked hydrogen H₂ can be accumulated. Accordingly, when the hydrogen sensor is disposed at the location of accumulation, the detection accuracy can be enhanced and the number of hydrogen sensors installed can be reduced.

The embodiment has been described above.

Note that the present disclosure is not limited to the description of the above-described embodiment, and various modifications can be made without departing from the gist thereof. In the following, variations will be described.

### [Variation 1]

The shape of cab floor 20 is not limited to that in the description of the present embodiment. The shape of cab floor 20 may be determined appropriately such that leaked hydrogen H₂ is accumulated at one location.

### [Variation 2]

The embodiment has been described in relation to the exemplary case where the fuel cell vehicle of the present disclosure is a truck, but the fuel cell vehicle may be of another vehicle type (for example, a bus or the like).

### INDUSTRIAL APPLICABILITY

The fuel cell vehicle of the present disclosure is useful for collecting leaked fuel.

1. A fuel cell vehicle, comprising:
a cab floor formed higher at a rear portion than at a front portion by a step portion obliquely inclined upward and rearward in a vehicle length direction; and
a fuel cell system disposed below the cab floor, the fuel cell vehicle being configured to travel using electric power generated by the fuel cell system, wherein
the rear portion of the cab floor has a shape for accumulating fuel leaking and ascending from the fuel cell system.

2. The fuel cell vehicle according to claim 1, wherein
the shape is such a shape that a rear end portion of the rear portion is obliquely inclined rearward and downward in the vehicle length direction.

3. The fuel cell vehicle according to claim 1, further comprising:
a sensor at a location where the fuel is accumulated, the sensor configured to detect the fuel.

4. The fuel cell vehicle according to claim 1, wherein
the fuel is hydrogen.
